(19) United States
(12) Patent Application Publication
(10) Pub. No.: US 2005/0111474 A1
(43) Pub. Date: May 26, 2005

(54) IP multicast communication system

(75) Inventor: Emiko Kobayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/024,494

(22) Filed: Dec. 30, 2004

Related U.S. Application Data
(63) Continuation of application No. PCT/JP02/11375, filed on Oct. 31, 2002.

(51) Int. Cl. H04L 12/28

(52) U.S. Cl. 370/432

(57) ABSTRACT

An IP multicast communication system includes a layer-2 switch for accommodating a plurality of recipients dynamically joining or not joining a multicast group, a layer-3 switch adapted to a subnet for receiving IP multicast data sent from a sender via an IP network and distributing the received IP multicast data to authorized recipients joining the multicast group via the layer-2 switch under control, and a controller for collectively managing recipient management information for authentication of the recipients obtained according to an Internet Group Management Protocol IGMP. The layer-3 switch authenticates the recipients according to the recipient management information adapted to its subnetwork among the recipient management information collectively managed by the controller. The layer-2 switch stops transmission of the IP multicast data or thins the IP multicast data sent to recipients that are determined to have made unauthorized accesses by the layer-3 switch.

### BACKGROUND OF THE INVENTION

The present invention relates to an IP (Internet Protocol) multicast communication system, and particularly to an IP multicast communication system that is capable of preventing or disturbing reception of multicast data through unauthorized access, by utilizing information based on the IGMP (Internet Group Management Protocol).

In a conventional IP multicast communication system, as shown in FIG. 1, a multicast router R-RT on the receiving side receives IP multicast data from a sender (strictly, including a sending terminal such as a host/server computer and its operator) through a multicast router T-RT on the sending side and an IP network NW.

A switching hub R-SW-HUB for the receiving-side subnetwork (subnet) receives the IP multicast data from the receiving-side multicast router R-RT and distributes the IP multicast data to a plurality of recipients A, B, and C that gained membership of the multicast group in advance (strictly, including user terminals and the users). When the system includes a single sender, the sending-side switching hub T-SW-HUB can be omitted.

In this IP multicast communication system, the IP multicast data (which is referred to also as multicast data or simply as data unless particular limitation is required) is sent to the recipients when the recipients make data reception requests or when the sender makes a data transmission request.

That is to say, when the sender sends out multicast data onto the IP network, and a recipient specifies an IP multicast address and the receiving-side multicast router defines a multicast routing protocol (a routing protocol such as the PIM-SM (Protocol Independent Multicast-Sparse Mode) or the PIM-DM (Protocol Independent Multicast-Dense Mode)), then the recipient can obtain the multicast data.

The multicast address is a class-D IP address and includes a multicast group ID. The multicast group ID is in a certain range of address values (e.g., 224. 0. 0.0-239. 255. 255. 255) and so it is easier to know the multicast address than to know a unicast address. It is therefore difficult to control access to multicast data from recipients and hence to prevent acquisition of multicast data by recipients making unauthorized access.

Also, in video distribution, which distributes data compressed by, e.g. MPEG2 (Moving Picture Experts Group-2), encrypting video multicast data (including moving picture data and audio data) for high speed and wide-band transmission (e.g. 6 Mbps) causes delay in data encryption and decryption. Accordingly, it is difficult to use encryption techniques in streaming.

On the other hand, in a conventional method in which a recipient obtains video by entering a password informed from the video sender, the communication between the video sender and the recipient is one-to-one communication and therefore traffic increases in proportion to the number of recipients, where delay in distribution of passwords may hinder provision of video. Also, this scheme requires management of recipients and passwords for each distributed program, which complicates processing on the management side.

In a method according to the Simple Multicast Receiver Access Control (All Provisions of Section 10 of RFC 2026), a recipient and a proximate multicast router use a public key and a secret key so that the multicast router can check the recipient for authentication according to the Internet Group Management Protocol IGMP to decide whether to accept or reject the recipient.

However, this method is very fragile when an authorized recipient is included in the same subnet; i.e. this method tends to suffer from masquerading as authorized recipients. When the Simple Multicast Receiver Access Control scheme is combined with an existing “peeping” technique called IGMP Snooping, the IGMP snooping in a switching hub causes propagation delay since a MAC (Media Access Control) address is read directly from the header of data flowing through ports and data is exchanged between ports connected with the sender and the destination.

### SUMMARY OF THE INVENTION

An object of the present invention is to provide a technique capable of preventing or disturbing reception of multicast data by unauthorized access, by utilizing information according to the Internet Group Management Protocol IGMP.

In order to achieve the above object, the present invention provides an IP multicast communication system, including:
a layer-2 switch that accommodates a plurality of recipients capable of dynamically joining or not joining a multicast group;
a layer-3 switch, for a subnetwork, that receives IP multicast data sent from a sender through an IP network and distributes, through the layer-2 switch subordinate to the layer-3 switch, the received IP multicast data to a plurality of authorized recipients joining the multicast group; and
a controller that collectively manages recipient management information for authentication of the recipients obtained according to an Internet Group Management Protocol IGMP;
wherein the layer-3 switch checking the recipients for authentication on the basis of recipient management information for the own subnetwork that is contained in the recipient management information collectively managed by the controller, and
the layer-2 switch ceasing transfer of the IP multicast data to a recipient that is judged by the layer-3 switch as having made unauthorized access, thinning out the IP multicast data, and sending the thinned-out data.

In the IP multicast communication system, the layer-2 switch may be a switching hub and the layer-3 switch may be a multicast router.

The controller as an authentication server has a table storing the recipient management information. The recipient management information collectively managed by the controller includes, for each the recipient, a multicast group address, an IP address, a MAC address, a multicast group membership level, a subnetwork address, and a flag for specifying a recipient making unauthorized access.

Further, when the layer-3 switch receives, through the layer-2 switch, a join message for joining the IP multicast group which is sent from the recipient according to the IGMP, and a subnetwork address of the recipient is absent in its own the recipient management information, then the layer-3 switch changes the direction and distributes a reporting message according to the IGMP to the layer-2 switch to cause the layer-2 switch to set a flag for specifying a recipient making unauthorized access.

The Internet Group Management Protocol IGMP is a protocol for distributing IP multicast data to a particular group identified with an IP multicast group address (a single IP destination address).

The present invention makes it possible to prevent or disturb reception of multicast data by recipients making unauthorized access and provides an IP multicast communication system with great security.

### BRIEF DESCRIPTION OF THE DRAWINGS

FIG. 1 shows a configuration example of a conventional IP multicast communication system.

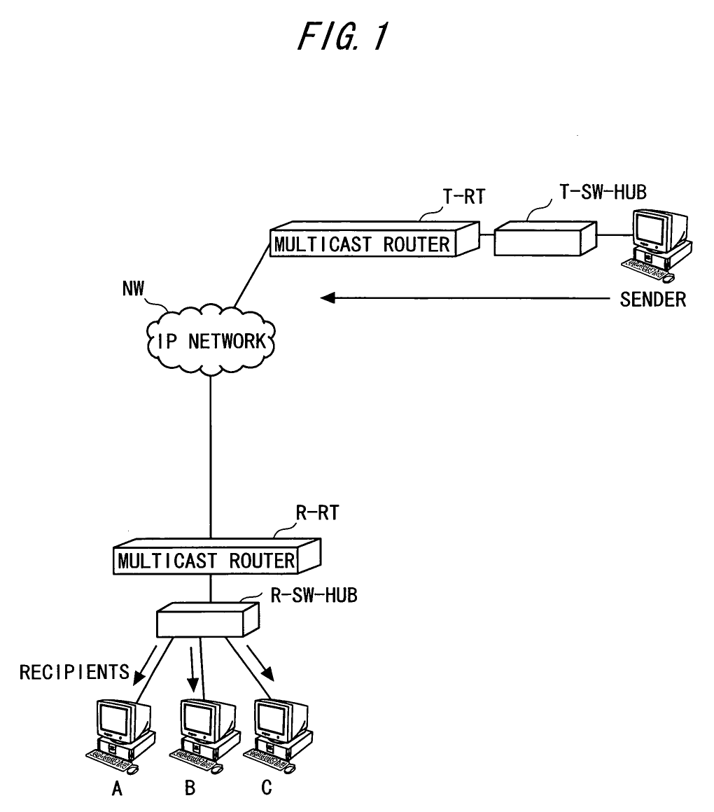

FIG. 2 shows a first configuration example of an IP multicast communication system according to the present invention.

FIG. 3 shows a second configuration example of the IP multicast communication system according to the present invention.

FIG. 4 is a flowchart of a process performed by an authentication server.

FIG. 5 is a flowchart of a process performed by the authentication server.

FIG. 6 is a flowchart of a process performed by a multicast router.

FIG. 7 is a flowchart of a process performed by the multicast router.

FIG. 8 is a flowchart of a process performed by the multicast router.

FIG. 9 is a flowchart of a process performed by a switching hub.

FIG. 10 is a flowchart of a process performed by the switching hub.

FIG. 11 is a flowchart of a process performed by the switching hub.

FIG. 12 is a flowchart of a process performed by recipients (recipients that desire to receive multicast data).

FIG. 13 is a flowchart of a process performed by recipients (recipients that desire to receive multicast data).

### DETAILED DESCRIPTION OF THE PREFERRED EMBODIMENTS

Next, an embodiment of the present invention is described referring to the drawings.

[Configurations of IP Multicast Communication System]

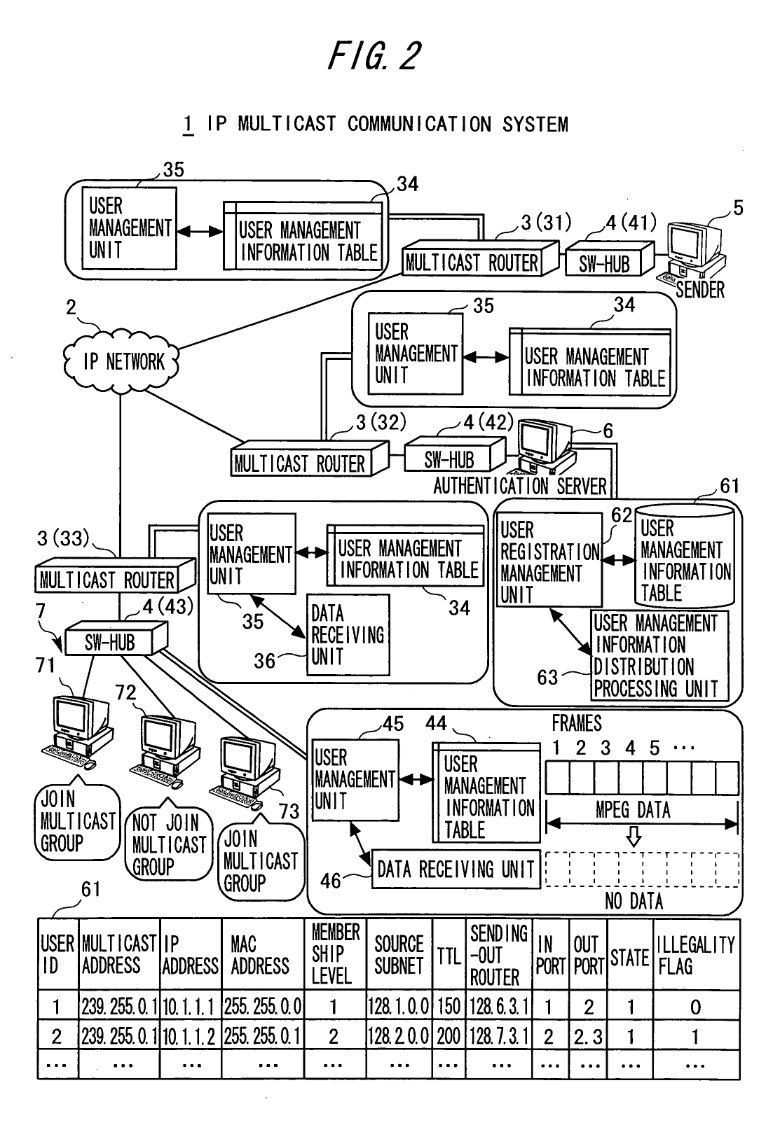

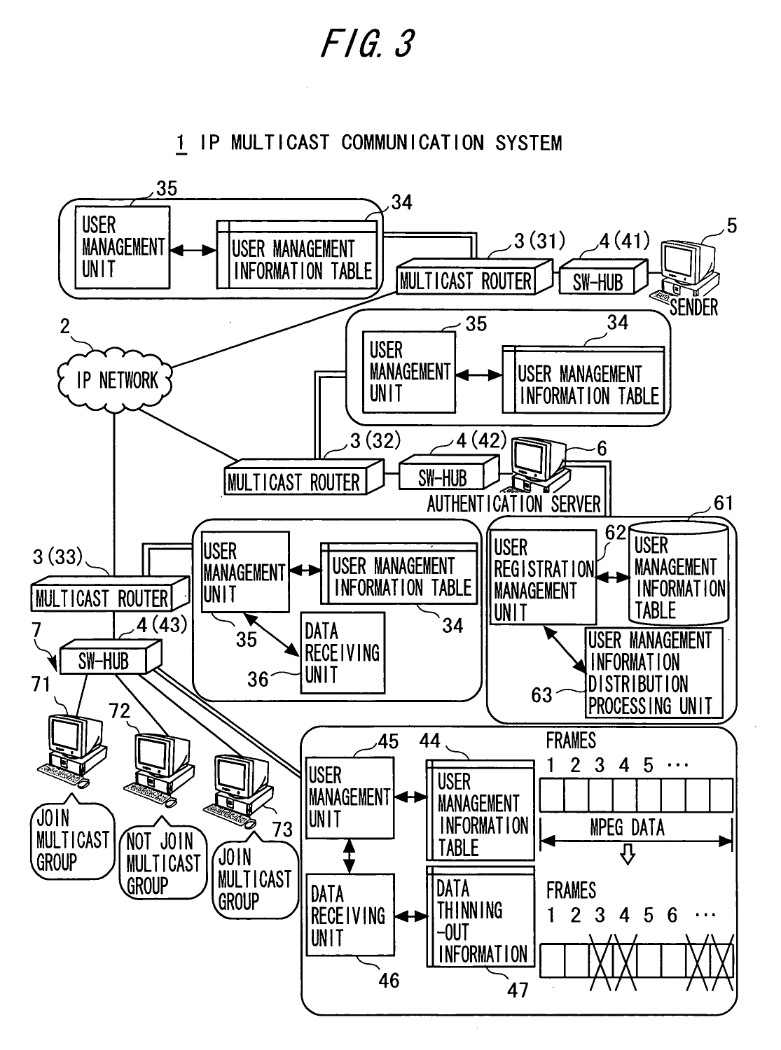

Referring to FIGS. 2 and 3 showing system configurations according to an embodiment of the present invention, an IP multicast communication system 1 includes multicast routers 3 (31, 32, and 33) connected to an IP network 2, e.g. the Internet.

These multicast routers 3 are provided for respective subnetworks (subnets) and connected to respective subordinate switching hubs (SW-HUBs) 4 (41, 42, and 43). The multicast routers 3 can be replaced by other layer-3 (L3) switches that support IP multicasting.

The switching hub 41 accommodates a sender 5 that sends IP multicast data (strictly, including a sending terminal such as a host/server computer and its operator). The switching hub 42 accommodates an authentication server 6. The switching hubs 41 and 42 may be omitted. Also, the switching hubs 41 and 42 may be replaced by other layer-2 (L2) switches.

The switching hub 43 accommodates a plurality of recipients 7 (71, 72, and 73: strictly, user terminals such as personal computers and the users) that are capable of dynamically joining or leaving (not joining) the multicast group. The switching hub 43 can be replaced by other L2 switch.

In the IP multicast communication system 1, the authentication server 6 manages authorized recipients 7 by utilizing information based on the Internet Group Management Protocol IGMP. For this purpose, the authentication server 6 has a user management information table 61 storing user management information that is authentication information about the multicast data recipients 7.

All multicast routers 31, 32, and 33 in the IP network 2, or strictly all multicast routers related to the edge of the IP network 2, and the receiving-side switching hub 43 accommodating the recipients 7 have their respective user management information tables 34 and 44 for storing user management information.

The receiving-side multicast router 33 for the recipients 7 checks for unauthorized access users (recipients) on the basis of the user management information in the user management information table 34.

In the IP multicast communication system 1 which adopts the first configuration shown in FIG. 2, the receiving-side switching hub 43 refers to the user management information table 44 and ceases distribution of multicast data (including moving picture data and audio data) to recipients 7 that desire data reception but are not registered to join the multicast group. This prevents unauthorized recipients 7 from receiving multicast data.

In an IP multicast communication system 1 which adopts the second configuration shown in FIG. 3, the receiving-side switching hub 43 refers to the user management information table 44 and thins out multicast data, e.g. moving picture data, and sends the thinned out data to recipients 7 that desire data reception but are not registered to join the multicast group. The thinning out of data can disturb the reception of multicast data by unauthorized recipients 7.

The layer configurations of the multicast routers 31, 32, and 33, the switching hub 43, and the authentication server 6 will be described in detail later.

[Functions of Authentication Server]

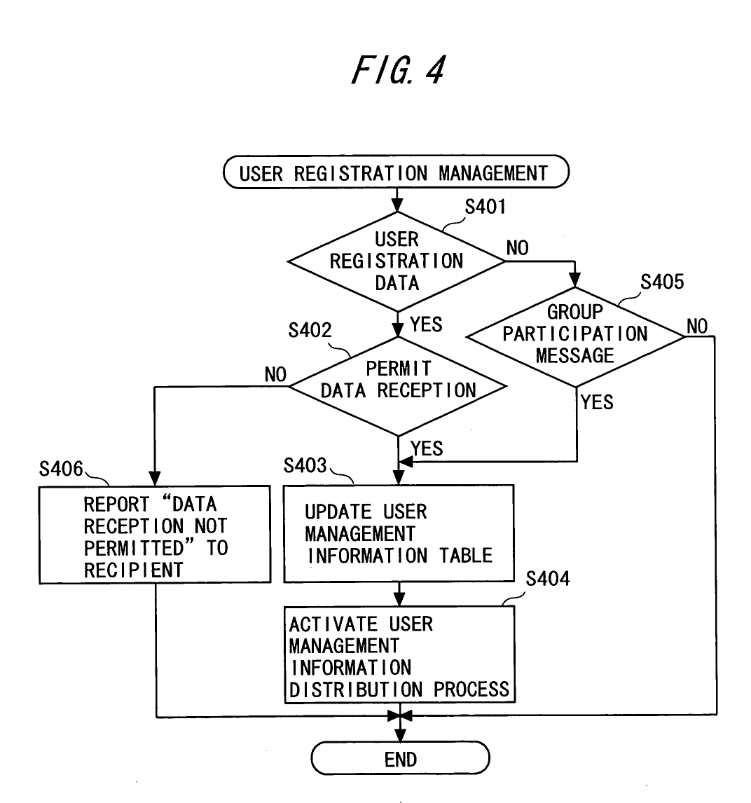

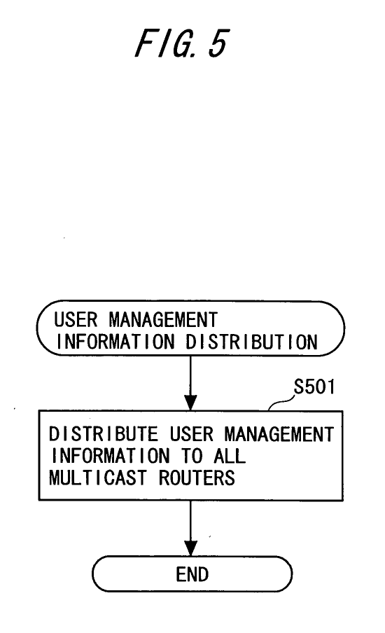

FIGS. 4 and 5 are flowcharts of processes performed by the authentication server 6 shown in FIGS. 2 and 3. Referring to FIGS. 2 to 5 together, the authentication server 6, managing the recipients 7 that desire to receive multicast data, has the following functions:

(1) The user registration management unit 62 in the authentication server 6 checks, on the basis of an IGMP message, to see whether data is for user registration, and performs the following process steps when the data is for user registration (S401 in FIG. 4).

(2) The user registration management unit 62 refers to the user management information table 61 to check attributes of the recipient 7 that desires to receive multicast data (the attributes include an IP multicast group address, IP address, MAC address, membership level, illegality flag, and so forth), and when the user registration management unit 62 permits reception of multicast data, it registers the recipient in the user management information table 61 and updates the user management information table 61 (S402 and S403).

(3) After updating the user management information table 61, the user registration management unit 62 activates a user management information distributing process (S404).

(4) Activated by the user registration management unit 62, a user management information distribution processing unit 63 cooperates with the user registration management unit 62 to distribute user management information corresponding to the contents of the user management information table 61, to all multicast routers 33 in the receiving-side subnet, through the switching hub 42 (S501 in FIG. 5). Just a single multicast router 33 is shown herein.

Also, in cooperation with the user registration management unit 62, the user management information distribution processing unit 63 distributes, through the switching hub 42, user management information which is part of the contents of the user management information table 61 (information required for routing) to the multicast routers 31 and 32 related to the edge of the IP network 2.

(5) When the user registration management unit 62 judges, in step S401, that the data is not for user registration, it then updates the user management information table 61 on the basis of a multicast group join message (IGMP Join message) or leave message (IGMP Leave message) (S405).

(6) When the user registration management unit 62 does not permit multicast data reception in step S402, it reports “not permitted” to the recipient 7 desiring reception of multicast data (S406).

[Functions of Multicast Router]

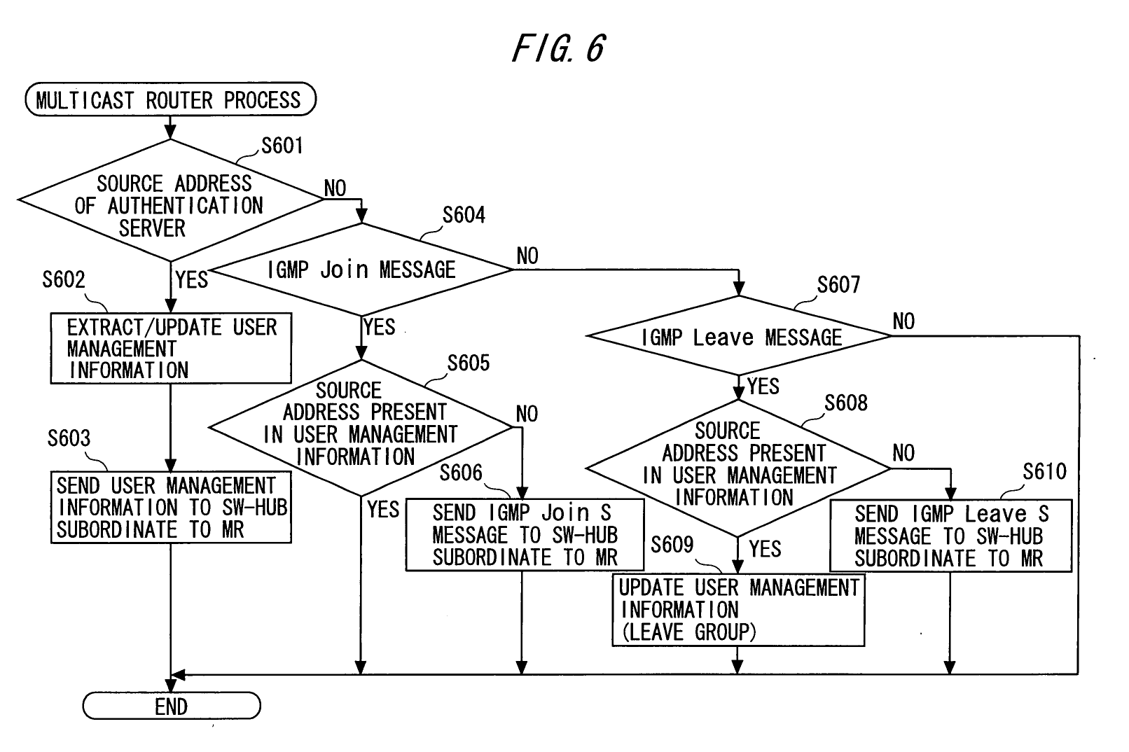

FIGS. 6, 7, and 8 are flowcharts of processes performed by the multicast router 33 of FIGS. 2 and 3. Referring to FIGS. 2, 3, and 6 to 8 together, the functions of the multicast router 33 are described.

(1) When the multicast router 33 receives the entire user management information corresponding to the contents of the user management information table 61 that is distributed from the authentication server 6, the user management unit 35 of the multicast router 33 extracts (specifies) only the management information about the users belonging to its subnet and updates the user management information table 34 on the basis of the specified user management information (S601 and S602 in FIG. 6).

In extracting the user management information about its own subnet, the user management unit 35 utilizes information such as the IP multicast group address (multicast address), the IP addresses of the recipients 71, 72, and 73, or the source (recipient) subnet address.

On the other hand, the user management units 35 of the multicast routers 31 and 32 related to the edge of the IP network 2 receive, from the authentication server 6, the user management information (information required for routing) that corresponds to part of the contents of the user management information table 61 and update their respective user management information tables 34 on the basis of the user management information.

(2) The user management unit 35 of the multicast router 33 sends to the subordinate switching hub 43 user management information that the switching hub 43 should store (hold) in its user management information table 44 (S603).

The user management information corresponding to the contents of the user management information table 61 of the authentication server 6 is distributed only at the time of initial introduction, and the user management information is updated thereafter utilizing IGMP Join S messages and IGMP Leave S messages and the switching hub 43 does not search the layer-3 (network layer) information at the port level, which avoids loads on the IP network 2.

As for the IGMP Join S message, when the multicast router 33 receives an IGMP Join (Group) message sent from a recipient 7 joining the multicast group, the multicast router 33 uses the IGMP Join S message to report to the switching hub 43 that an IGMP Join message was sent.

As for the IGMP Leave S message, when the multicast router 33 receives an IGMP Leave (Group) message sent from a recipient 7 leaving the multicast group, the multicast router 33 uses the IGMP Leave S message to report to the switching hub 43 that an IGMP Leave message was sent.

(3) When the data receiving unit 36 of the multicast router 33 receives an IGMP Join message from the subordinate switching hub 43, the user management unit 35 checks the subnet IP address of the message source (recipient) (which may be referred to simply as a source address) with the contents of the user management information table 34 to check the recipient 7 for authentication. Then, when the IP address is present in the user management information table 34, the user management unit 35 directly ends the process, and when the IP address is absent, the user management unit 35 changes the direction and sends an IGMP Join S message to the switching hub 43 (S604, S605, and S606).

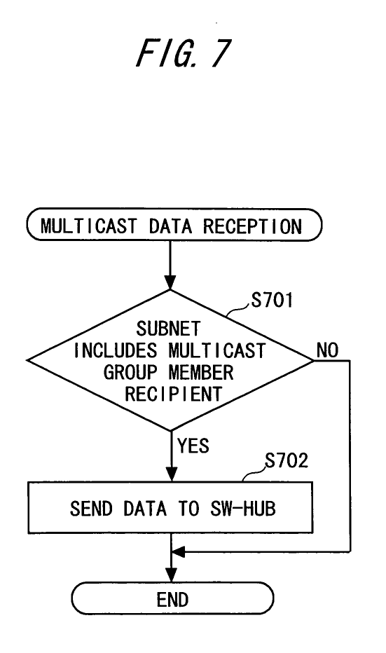

(4) When the multicast router 33 receives multicast data and at least one recipient 7 in the subnet is a member of the multicast group, then the user management unit 35 sends the data to the switching hub 43 to relay the multicast data, destined to that group, into the entire area of the subnet (S701 and S702 in FIG. 7).

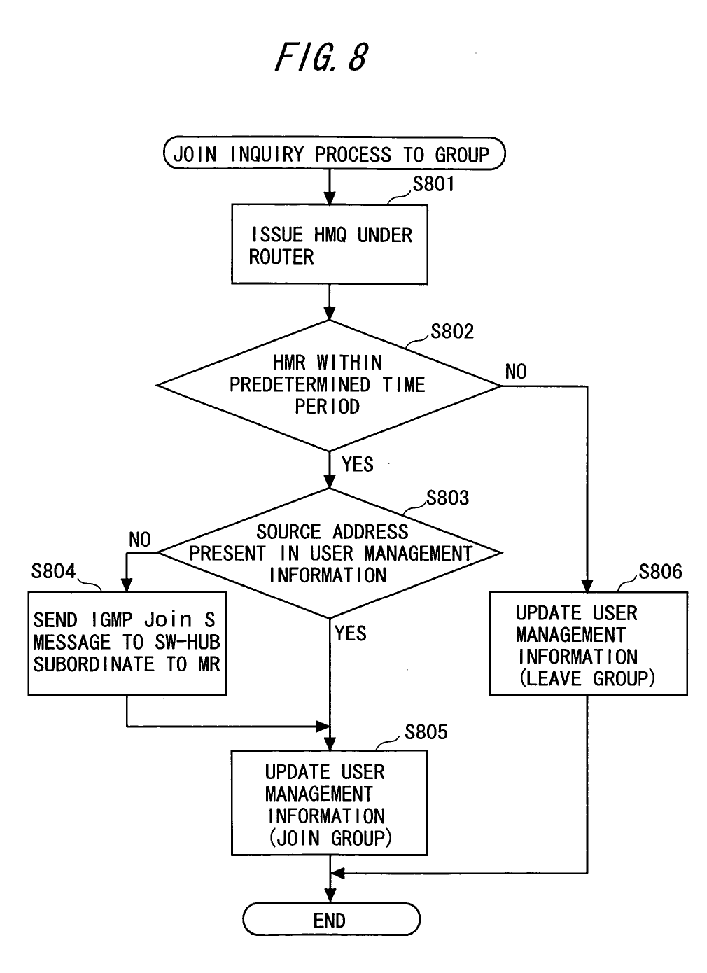

(5) The user management unit 35 issues IGMP HMQ (IGMP Host Membership Query) messages to regularly inquire of the recipients 7 whether they continue membership in the multicast group (S801 in FIG. 8).

(6) When the multicast router 33 receives an IGMP HMR (IGMP Host Membership Report) message within a predetermined time period, then the user management unit 35 checks the source address of the message with the contents of the user management information table 34. When the source address is present in the user management information table 34, the user management unit 35 directly goes to the next step, and when the source address is absent, the user management unit 35 changes the direction and sends an IGMP Join S message to the subordinate switching hub 43 (S802, S803, and S804).

The IGMP HMR message is a message that a recipient 7 sends to the multicast router 33 in response to the IGMP HMQ message to report the multicast address at which the recipient 7 desires to receive data.

(7) When the data receiving unit 36 of the multicast router 33 receives an IGMP Leave message from the subordinate switching hub 43, the user management unit 35 checks the source address of the message with the contents of the user management information table 34. When the user management information table 34 defines the membership in the multicast group, the user management unit 35 deletes the membership in the multicast group and updates the user management information table 34 (S607, S608, and S609).

(8) When the user management information table 34 does not define the membership in the multicast group, the user management unit 35 changes the direction and sends an IGMP Leave S message to the switching hub 43 after updating the user management information table 34 (S610).

(9) When a plurality of multicast routers 33 are present in the receiving-side subnet, the multicast routers 33 make a selection among themselves so that the router having the largest IP address functions as a designated router. The designated router issues IGMP HMQ messages and sends to the authentication server 6 multicast group join message or leave message from the recipients 7 (S805 and S806).

[Functions of Switching Hub]

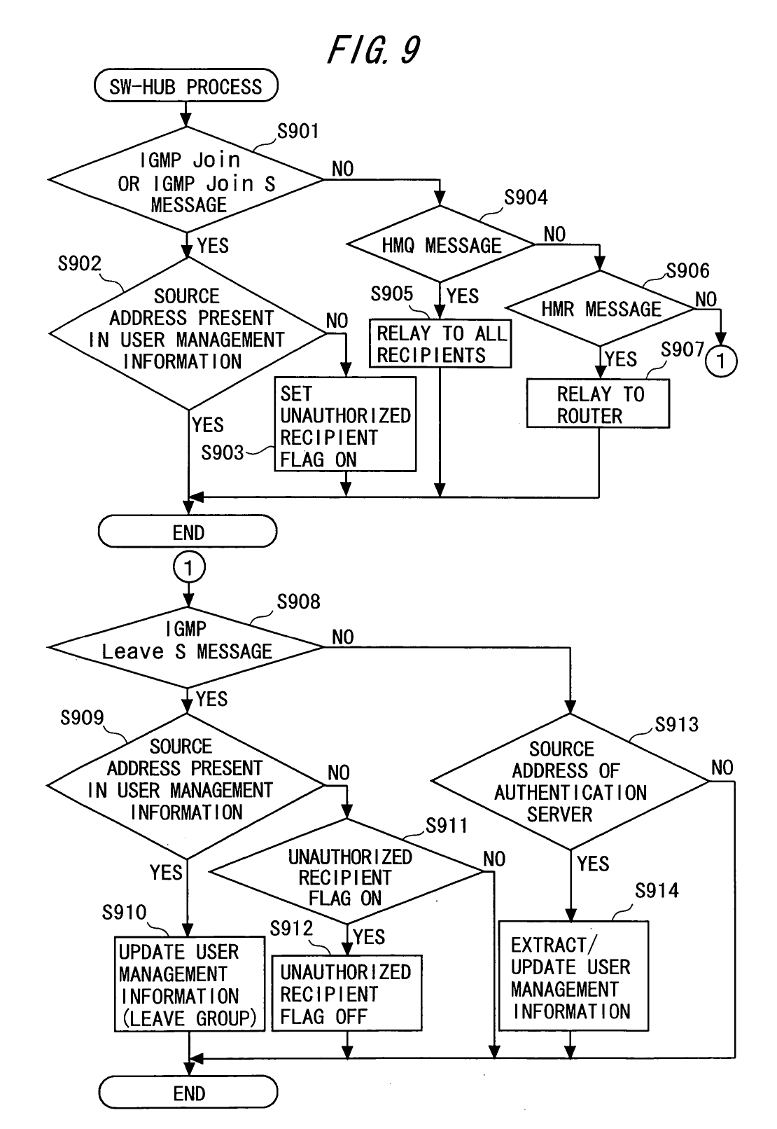

FIGS. 9, 10, and 11 are flowcharts of processes performed by the switching hub 43 shown in FIGS. 2 and 3. Referring to FIGS. 2, 3, and 9 to 11 together, the functions of the switching hub 43 are described.

(1) When the data receiving unit 46 of the switching hub 43 receives user management information distributed from the multicast router 33, the user management unit 45 registers the user management information in the user management information table 44.

(2) With an IGMP Join S message received from the multicast router 33, the user management unit 45 checks the source address with the user management information in the user management information table 44. When the source address is absent in the user management information table 44, the user management unit 45 regards the recipient 7 as being unauthorized and sets (to 1) an unauthorized recipient identify flag (an illegality flag or an unauthorized recipient flag) and updates the user management information table 44 (S901, S902, and S903 in FIG. 9).

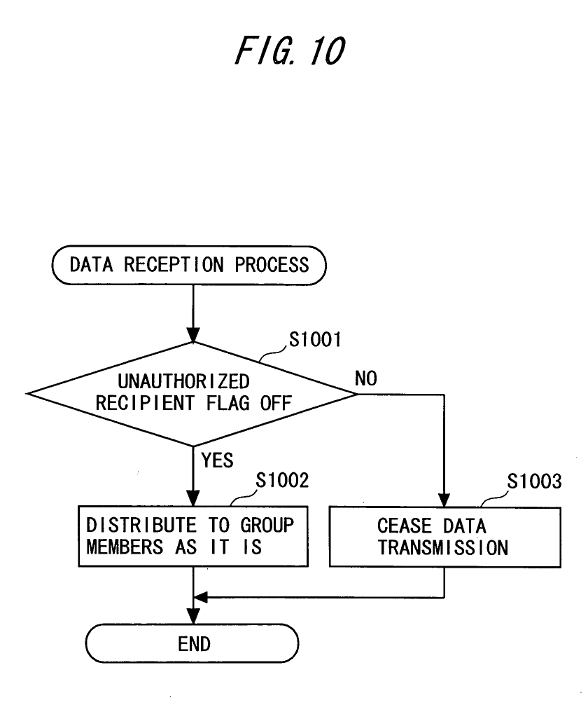

(3) The user management unit 45, referring to the user management information table 44, distributes intact multicast data to recipients 7 with the illegality flags being off and ceases distribution of multicast data (MPEG data) to recipients 7 with the illegality flags being on (S1001, S1002, and S1003 in FIG. 10, and refer to the configuration of FIG. 2). The user management unit 45 does not distribute data to recipients 7 that did not submit a multicast data reception request, i.e. to recipients 7 that did not join the multicast group in advance.

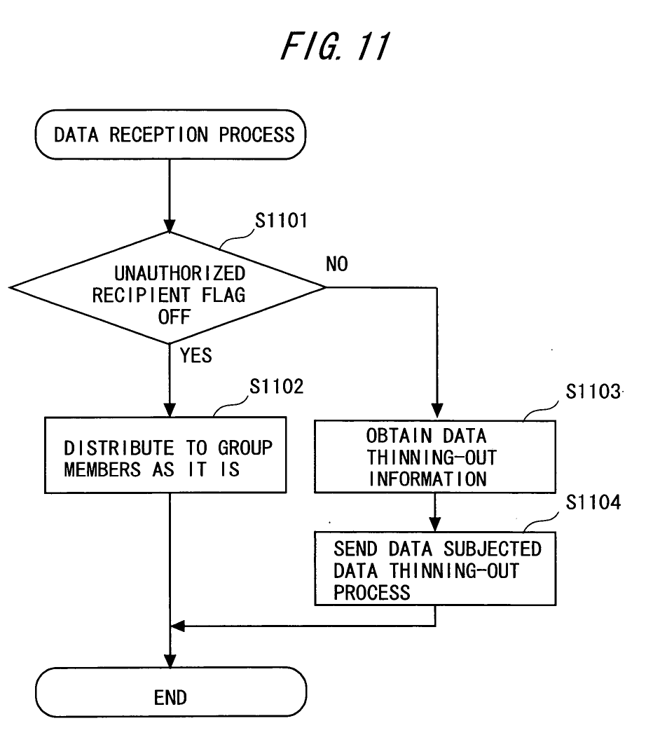

(4) When it is permissible to allow recipients 7 with illegality flags being on to know the outlines of data, the user management unit 45 may delete data portions of frames, i.e. thin out moving picture data, for example, and send the thinned out data. Unauthorized recipients 7 then receive data destructed by the data thinning-out process, i.e. data deteriorated in quality (S1101 to S1104 in FIG. 11, also see the configuration of FIG. 3).

(5) When the data receiving unit 46 receives an IGMP HMQ message from the multicast router 33, the user management unit 45 relays the message to all ports, i.e. to all recipients 7 (71, 72, and 73) (S904 and S905).

(6) When the data receiving unit 46 of the switching hub 43 receives an IGMP HMR message sent from a recipient 7, the user management unit 45 relays the IGMP HMR message to the multicast router 33 (S906 and S907).

(7) When the user management unit 45 refers to an IGMP Leave S message and judges that the source address corresponding to the recipient 7 is defined in the user management information table 44 as a member of the multicast group, the user management unit 45 deletes the membership in the group (S908, S909, and S910).

(8) When the user management unit 45 judges it is not defined, the user management unit 45 refers to the port information in the user management information table 44 to see whether the illegality flag is on or off. When the flag is on, the user management unit 45 unsets the flag (sets the flag too) and updates the user management information table 44 (S908, S909, S911, and S912).

(9) When the user management unit 45 judges that, in step S908, the message is not an IGMP Leave S message and that the source address corresponds to the authentication server 6, then the user management unit 45 extracts the user management information corresponding to its subnet and updates the user management information table 44 (S913 and S914).

[Functions of Recipients (Who Desire to Receive Multicast Data)]

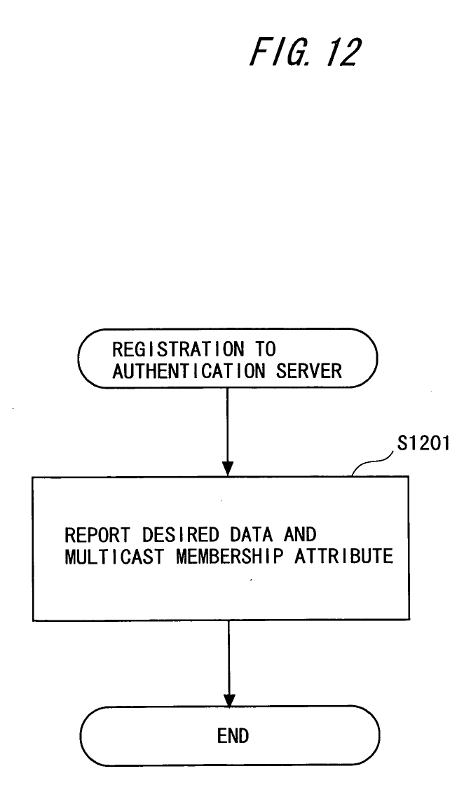

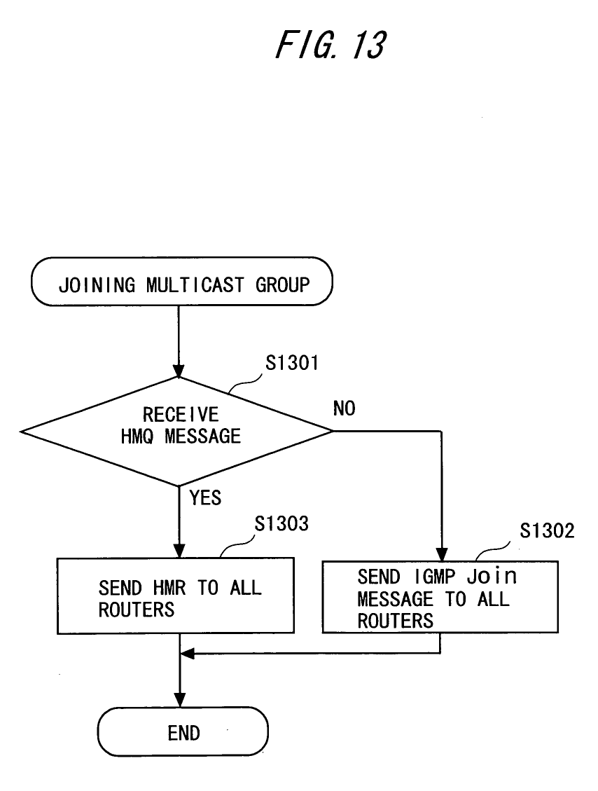

FIGS. 12 and 13 are flowcharts of processes performed by recipients 7 (that desire to receive multicast data) shown in FIGS. 2 and 3. Referring to FIGS. 2, 3, 12, and 13 together, the functions of the recipients 7, as applicants for reception of multicast data, are described.

(1) A recipient 7 that desires to receive multicast data (video including moving picture data and audio data) reports, by unicast, data (video) the recipient 7 desires to receive, the multicast membership attribute (membership level) of the recipient 7, etc., so as to register itself in the authentication server 6 (S1201 in FIG. 12).

(2) The recipient 7 issues an IGMP Join message to join the multicast group. The issued IGMP Join message is sent through the switching hub 43 to all multicast routers 33 in the receiving-side subnet (S1301 and S1302 in FIG. 13).

(3) When an applicant 7 for reception that desires to continue the membership in the multicast group receives an IGMP HMQ message, the applicant 7 issues an IGMP HMR message. The issued IGMP HMR message is sent to all multicast routers 33 through the switching hub 43 (S1301 and S1303).

(4) An unauthorized recipient 7 cannot normally receive data unless it issues an IGMP Leave message. That is to say, an unauthorized recipient 7 can leave the multicast group by issuing an IGMP Leave message to all multicast routers 33. After leaving the group, the unauthorized recipient 7 does not receive quality-deteriorated data.

[First Operation Example of IP Multicast Communication System]

Next, referring to FIG. 2 and relevant flowcharts, a first example of operation of the IP multicast communication system is described.

In the IP network system 1, the authentication server 6 manages (registers, deletes, and updates) the sender 5 that sends multicast data and the recipients 7 that are authorized to receive the data. The authentication server 6 utilizes the user management information table 61 in managing the recipients 7 authorized to receive multicast data.

A recipient 7, as an applicant for reception of multicast data, applies to the authentication server 6 by unicasting information indicating data it desires to receive, multicast group membership level, etc. The multicast group membership levels include: Level 0—no sending and no receiving; Level 1—sending but no receiving; and Level 2—sending and receiving.

The user registration management unit 62 of the authentication server 6 examines the application from the recipient 7 referring to the user management information previously registered in the user management information table 61. After the examination, when permitting reception, the user registration management unit 62 registers the user management information in the user management information table 61 and updates the user management information table 61.

As shown in FIG. 2, the user management information table 61 stores user management information for each recipient 7, including user ID, IP multicast group address (multicast address) IP address, MAC address, multicast group membership level, source (recipient) subnet address, TTL (Time to Live: a time after which the entry can be deleted from the table), Out router (the preceding hop router) address, In port, Out ports, state of availability of ports of the switching hub 43, illegality flag, and so on.

The user management information distribution processing unit 63 of the authentication server 6 distributes user management information contained in the user management information table 61 to the multicast routers 31, 32, and 33.

The user management units 35 of all multicast routers 33 in the receiving-side subnet (a single multicast router 33 is shown herein) extract only the information about their own subnet on the basis of particular information contained in the user management information distributed from the authentication server 6 (e.g. multicast address), register the information in the corresponding user management information tables 34, and send user management information to the subordinate switching hubs 43.

The user management unit 45 of the switching hub 43 extracts user management information about users belonging to its own subnet on the basis of MAC address contained in the user management information received from the multicast router 33, and registers the information in the user management information table 44 in the switching hub 43.

An authorized recipient 7 declares, in order to receive multicast data, to all multicast routers 33 present in the receiving-side subnet, that the recipient 7 desires multicast group data. For this purpose, the authorized recipient 7 sends an IGMP HMR message for requesting multicast group membership.

The multicast router 33 in the receiving-side subnet receives the IGMP HMR message and then the user management unit 35 checks the source address of the message with the contents of the user management information table 34. When the source address is present in the user management information table 34, the user management unit 35 directly goes to the next step, and when the source address is absent, it changes the direction and sends an IGMP Join S message to the switching hub 43.

The switching hub 43 receives the IGMP Join S message and the user management unit 45 checks the source address with the contents of the user management information table 44. When the source address is absent in the user management information table 44, the user management unit 45 regards the recipient 7 as being unauthorized, sets the illegality flag on, and updates the user management information table 44.

When the data receiving unit 36 of the multicast router 33 receives multicast data and the subnet includes at least one recipient 7 joining the multicast group, then the user management unit 35 sends the data to the switching hub 43 to relay the multicast data destined to that group into the entire area of the subnet.

The user management unit 45 of the switching hub 43 refers to the user management information table 44, and distributes the data to recipients 7 with the illegality flag being off and ceases data transfer to recipients 7 with illegality flag being on.

[Second Operation Example of IP Multicast Communication System]

Next, referring to FIG. 3 and relevant flowcharts, a second example of operation of the IP multicast communication system is described.

In the IP network system 1, the authentication server 6 manages (registers, deletes, and updates) the sender 5 that sends multicast data and the recipients 7 that are authorized to receive the data. The authentication server 6 utilizes the user management information table 61 in managing the recipients 7 authorized to receive multicast data.

A recipient 7, as an applicant for reception of multicast data, applies to the authentication server 6 by unicasting information indicating data it desires to receive, multicast group membership level, etc.

The user registration management unit 62 of the authentication server 6 examines the application from the recipient 7 referring to the user management information previously registered in the user management information table 61. After the examination, when permitting reception, the user registration management unit 62 registers the user management information in the user management information table 61 and updates the user management information table 61.

The user management information distribution processing unit 63 of the authentication server 6 distributes user management information contained in the user management information table 61 to the multicast routers 31, 32, and 33.

The user management units 35 of all multicast routers 33 in the receiving-side subnet (a single multicast router 33 is shown herein) extract only the information about their own subnet on the basis of particular information contained in the user management information distributed from the authentication server 6 (e.g. multicast address), register the information in the corresponding user management information tables 34, and send user management information to the subordinate switching hubs 43.

The user management unit 45 of the switching hub 43 extracts user management information about users belonging to its own subnet on the basis of MAC address contained in the user management information received from the multicast router 33, and registers the information in the user management information table 44 in the switching hub 43.

An authorized recipient 7 declares, in order to receive multicast data, to all multicast routers 33 present in the receiving-side subnet, that the recipient 7 desires multicast group data. For this purpose, the authorized recipient 7 sends an IGMP HMR message for requesting multicast group membership.

The multicast router 33 in the receiving-side subnet receives the IGMP HMR message and then the user management unit 35 checks the source address of the message with the contents of the user management information table 34. When the source address is present in the user management information table 34, the user management unit 35 directly goes to the next step, and when the source address is absent, it sends an IGMP Join S message to the switching hub 43.

The switching hub 43 receives the IGMP Join S message and the user management unit 45 checks the source address with the contents of the user management information table 44. When the source address is absent in the user management information table 44, the user management unit 45 regards the recipient 7 as being unauthorized, sets the illegality flag on, and updates the user management information table 44.

When the data receiving unit 36 of the multicast router 34 receives multicast data and the subnet includes at least one recipient 7 joining the multicast group, then the user management unit 35 sends the data to the switching hub 43 to relay the multicast data destined to that group into the entire area of the subnet.

The user management unit 45 of the switching hub 43 refers to the user management information table 44, and distributes the data to recipients 7 with the illegality flag being off. With recipients 7 with the illegality flag being on, the user management unit 45 refers, through the data receiving unit 46, to data thinning-out information 47 that defines, e.g. sending only two data frames out of every four frames, and sends the thinned out data.

Destructing about 5% of entire multicast data deteriorates quality. An unauthorized recipient 7 thus receives quality-deteriorated data destructed by the thinning-out. The unauthorized recipient 7 continuously receives destructed data until it issues an IGMP Leave message. The unauthorized recipient 7 can reject the reception of quality-deteriorated data by issuing an IGMP Leave message to all multicast routers 33 to leave the multicast group.

The multicast router 33 receives the IGMP Leave message and then checks the source address of the message with the contents of the user management information table 34. When the user management information table 34 defines the membership in the multicast group, the multicast router 33 deletes the membership and updates the user management information.

After updating the user management information in the user management information table 34, the multicast router 33 changes the direction and sends an IGMP Leave S message to the switching hub 43.

The switching hub 43 refers to the IGMP Leave S message, and when the user management information table 44 defines the membership in the multicast group, the switching hub 43 deletes the membership, and then refers to the port information of the switching hub 43 registered in the user management information table 44, and when the illegality flag is on, the switching hub 43 unsets the flag and updates the user management information.

Among multicast routers 33, the router having the largest IP address sends to the authentication server 6 multicast group join messages and leave messages from recipients 7. The authentication server 6 updates the user management information on the basis of the messages. An unauthorized recipient 7 does not receive quality-deteriorated data after leaving the group.

1. An IP multicast communication system, comprising:
a layer-2 switch accommodating a plurality of recipients capable of dynamically joining or not joining a multicast group;
a layer-3 switch, for a subnetwork, receiving IP multicast data sent from a sender through an IP network and distributing, through the layer-2 switch subordinate to the layer-3 switch, the received IP multicast data to a plurality of authorized recipients joining the multicast group; and
a controller collectively managing recipient management information for authentication of the recipients obtained according to an Internet Group Management Protocol IGMP;
wherein the layer-3 switch checking the recipients for authentication on the basis of recipient management information for the own subnetwork that is contained in the recipient management information collectively managed by the controller, and
the layer-2 switch ceasing transfer of the IP multicast data to a recipient that is judged by the layer-3 switch as having made unauthorized access.

2. An IP multicast communication system, comprising:
a layer-2 switch accommodating a plurality of recipients capable of dynamically joining or not joining a multicast group;
a layer-3 switch, for a subnetwork, receiving IP multicast data sent from a sender through an IP network and distributing, through the layer-2 switch subordinate to the layer-3 switch, the received IP multicast data to a plurality of authorized recipients joining the multicast group; and
a controller collectively managing recipient management information for authentication of the recipients obtained according to an Internet Group Management Protocol IGMP;
wherein the layer-3 switch checking the recipients for authentication on the basis of recipient management information for the subnetwork that is contained in the recipient management information collectively managed by the controller, and
the layer-2 switch thinning out the IP multicast data and sending the thinned-out IP multicast data to a recipient that is judged by the layer-3 switch as having made unauthorized access.

3. The IP multicast communication system according to claim 1 or 2, wherein the layer-2 switch comprises a switching hub.

4. The IP multicast communication system according to claim 1 or 2, wherein the layer-3 switch comprises a multicast router.

5. The IP multicast communication system according to claim 1 or 2, wherein the controller has a table storing the recipient management information.

6. The IP multicast communication system according to claim 1 or 2, wherein the recipient management information collectively managed by the controller includes, for each the recipient, a multi cast group address, an IP address, a MAC address, a multicast group membership level, a subnetwork address, and a flag for specifying a recipient making unauthorized access.

7. The IP multicast communication system according to claim 1 or 2, wherein when the layer-3 switch receives, through the layer-2 switch, a join message for joining the IP multicast group which is sent from the recipient according to the IGMP, and a subnetwork address of the recipient is absent in its own the recipient management information, then the layer-3 switch changes the direction and distributes a reporting message according to the IGMP to the layer-2 switch to cause the layer-2 switch to set a flag for specifying a recipient making unauthorized access.
